(19) United States
(12) Patent Application Publication
(10) Pub. No.: US 2026/0175618 A1
(43) Pub. Date: Jun. 25, 2026

(54) COUPLED TORSION BEAM AXLE TYPE SUSPENSION SYSTEM

(71) Applicants: Hyundai Motor Company, Seoul (KR); Kia Corporation, Seoul (KR)

(72) Inventors: Daeki Jeong, Hwaseong-si (KR); Won Hae Lee, Seoul (KR); Jongchan Baek, Hwaseong-si (KR); Sujin Lee, Hwaseong-si (KR); Hyejin Han, Hwaseong-si (KR)

(21) Appl. No.: 19/327,127

(22) Filed: Sep. 12, 2025

(30) Foreign Application Priority Data
Dec. 24, 2024 (KR) 10-2024-0195135

(51) Int. Cl. B60B 27/02; B60B 27/00

(52) U.S. Cl. CPC B60B 27/02; B60B 27/0005; B60B 27/0052; B60B 27/0068; B60B 2900/111; B60B 2900/112; B60B 2900/113; B60B 2900/114; B60B 2900/115; B60B 2900/116; B60B 2900/531; B60B 2900/541

(57) ABSTRACT

A coupled torsion beam axle type suspension system includes a coupled torsion beam axle, a spindle plate mounted on the coupled torsion beam axle and having a mount surface formed thereon, a wheel bearing assembly mounted on the spindle plate, and a brake caliper mounted on the spindle plate, wherein the wheel bearing assembly and the brake caliper are mounted on the mount surface which has a flat shape.

### CROSS-REFERENCE TO RELATED APPLICATIONS

This application claims priority to and the benefit of Korean Patent Application No. 10-2024-0195135 filed with the Korean Intellectual Property Office on Dec. 24, 2024, the entire contents of which are incorporated herein by reference.

### TECHNICAL FIELD

The present invention relates to a coupled torsion beam axle type suspension system, and more particularly, the present disclosure relates to a coupled torsion beam axle type suspension system having a simplified structure and improved ease of assembly.

### BACKGROUND

In general, the coupled torsion beam axle type suspension system plays the role of a structure that supports and mounts the springs, shock absorbers, and axles, and also plays the role of roll strength tuning that controls the vehicle movement.

The spindle plate and spindle bracket applied to the coupled torsion beam axle type suspension system play the role of fixing the axle (bearing, caliper, etc.).

Typically, a coupled torsion beam axle type suspension system with a spindle plate applied is called a direct-type coupled torsion beam axle type suspension system, and a coupled torsion beam axle type suspension system with a spindle bracket applied is called an offset-type coupled torsion beam axle type suspension system.

In the case of the spindle plate, machining must be performed twice or more due to the difference in steps between the bearing mount surface and the caliper mount surface, and if the parts are assembled without additional machining of the bearing mount surface, the alignment dispersion of the vehicle may be large.

If a spindle bracket is applied, the alignment dispersion of the vehicle can be reduced by additionally processing the bearing mount surface, but a separate mounting bracket must be added for the caliper mount, which is disadvantageous in terms of weight.

Additionally, since neither type has a surface to mount the wheel speed sensor, a bearing with an integrated sensor must be used.

The information contained in this background section is intended to promote understanding of the background of the invention and may include matters that are not conventional art already known to a person of ordinary skill in the field to which this technology belongs.

### SUMMARY

The present disclosure attempts to provide a coupled torsion beam axle type suspension system having a simplified structure and improved ease of assembly.

A coupled torsion beam axle type suspension system according to a disclosure example may include a coupled torsion beam axle, a spindle plate mounted on the coupled torsion beam axle and having a mount surface formed thereon, a wheel bearing assembly mounted on the spindle plate, and a brake caliper mounted on the spindle plate, and wherein the wheel bearing assembly and the brake caliper are mounted on the mount surface which has a flat shape.

The mount surface may be a flat surface without steps.

A bearing assemble portion for mounting the wheel bearing assembly and a caliper assemble portion for mounting the brake caliper may be formed on the mount surface.

The bearing assemble portion and the caliper assemble portion may be each formed by a plurality of holes.

The coupled torsion beam axle type suspension system according to a disclosure example may further include a wheel speed sensor bracket mounted on the mount surface, and a wheel speed sensor mounted on the wheel speed sensor bracket.

The spindle plate may have a speed sensor bracket mount hole formed to mount the wheel speed sensor bracket.

The spindle plate may have a speed sensor hole formed into which the wheel speed sensor is inserted.

The coupled torsion beam axle type suspension system according to a disclosure example may further include an encoder ring mounted on the wheel bearing assembly, and a sensing unit of the wheel speed sensor may be arranged adjacent to the encoder ring.

The wheel bearing assembly may further include a disk mount surface formed to allow a brake disk to be mounted, and an imaginary extension line of a brake surface where a brake pad of the brake caliper and a brake disk come into contact may be positioned between an imaginary extension line of the disk mount surface and an imaginary extension line of the mount surface of the spindle plate.

According to the disclosure example of the coupled torsion beam axle type suspension system, alignment dispersion may be reduced by forming a flat mount surface on the spindle plate.

According to the disclosure example of the coupled torsion beam axle type suspension system, the entire weight may be reduced with a simple configuration.

According to the disclosure example of the coupled torsion beam axle type suspension system, a wheel speed sensor bracket is applied to simplify the structure and improve ease of assembly.

In addition, any effects that can be obtained or expected due to an embodiment are directly or implicitly disclosed in the detailed description of an embodiment. That is, various effects predicted according to an embodiment will be disclosed in the detailed description that follows.

### BRIEF DESCRIPTION OF THE DRAWINGS

These drawings are intended for reference in explaining exemplary embodiments of the present invention, and therefore, the technical ideas of the present invention should not be construed as being limited to the accompanying drawings.

FIG. 1 is a perspective view of a coupled torsion beam axle type suspension system according to the disclosure example.

FIG. 2 is a partial perspective view of a coupled torsion beam axle type suspension system according to the disclosure example.

FIG. 3 is a partial projection drawing of a coupled torsion beam axle type suspension system according to the disclosure example.

FIG. 4 is a perspective view of the spindle plate of a coupled torsion beam axle type suspension system according to the disclosure example.

FIG. 5 is a perspective view of a wheel speed sensor bracket of a coupled torsion beam axle type suspension system according to the disclosure example.

FIG. 6 is a cross-sectional view along line VI-VI of FIG. 3.

FIG. 7 is a cross-sectional view along line VII-VII of FIG. 3.

### DESCRIPTION OF SYMBOLS

1: coupled torsion beam axle type suspension system
10: coupled torsion beam axle
12: trailing arm
14: bush
16: wheel stud
20: spindle plate
22: mount surface
24: bearing assemble portion
26: caliper assemble portion
30: speed sensor bracket mount hole
32: speed sensor hole
40: wheel bearing assembly
42: wheel bearing assembly mount bolt
44: first body
46: second body
48: bearing
50: bearing retainer
52: flange
54: encoder ring
60: disk mount surface
62: brake disk
64: disk slope portion
66: pad contacting surface
70: brake caliper
72: brake pad
74: brake caliper mount bolt
90: wheel speed sensor bracket
92: wheel speed sensor
94: sensing unit
96: speed sensor bracket mount bolt
97: bracket connection hole
98: speed sensor insertion hole
100: sensor connection hole
102: sensor connection bolt

The drawings referenced above are not necessarily to scale, but should be understood as presenting rather simplified representations of various features illustrating the basic principles of the present invention. For example, certain design features of the present invention, including particular dimensions, direction, position, and shape, will be determined in part by the particular intended application and usage environment.

### Detailed Description of Illustrative Embodiments

The present invention will be described more fully hereafter with reference to the accompanying drawings, in which embodiments of the invention are shown. As those skilled in the art would realize, the described embodiments may be modified in various different ways, all without departing from the spirit or scope of the present invention.

In order to clearly explain the present invention, parts irrelevant to the description are omitted, and the same reference numerals are used for identical or similar components throughout the specification.

The size and thickness of each component shown in the drawing are arbitrarily shown for better understanding and ease of description, and the present invention is not necessarily limited to what is shown in the drawing, and the thickness is shown by enlarging it in order to clearly express various parts and regions.

Throughout the specification, whenever a part is said to include a certain component, this does not mean that it excludes other components, but rather that it may include other components, unless otherwise specifically stated.

Additionally, terms such as . . . unit, . . . means, etc. described in the specification mean comprehensive units of configuration that perform at least one function or operation.

When this disclosure states that a part, such as a layer, membrane, region, or plate, is “over” another part, this includes not only cases where it is directly over the other part, but also cases where there are other parts in between.

In contrast, when an element is referred to as being “directly on” another element, there are no intervening elements present.

The terms “vehicle”, “car”, “vehicle of”, “vehicular” or other similar terms used in this specification include vehicles including sports utility vehicles (SUVs), buses, trucks, passenger vehicles including various commercial vehicles, ships including various types of boats and vessels, aircraft and the like, as well as hybrid vehicles, electric vehicles, plug-in hybrid electric vehicles, hydrogen fuel vehicles and other alternative fuel (e.g., fuel obtained from resources other than petroleum) vehicles.

An embodiment will hereinafter be described in detail with reference to the accompanying drawings.

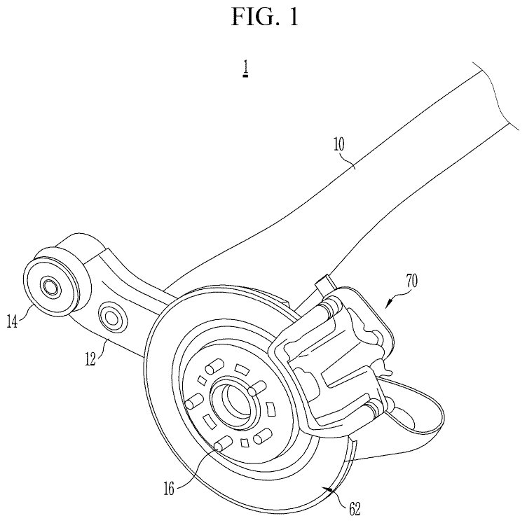

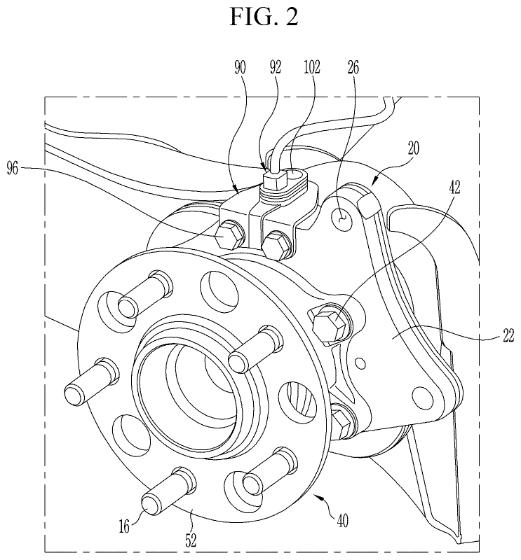

FIG. 1 is a perspective view of a coupled torsion beam axle type suspension system according to the disclosure example, and FIG. 2 is a partial perspective view of a coupled torsion beam axle type suspension system according to the disclosure example.

Referring to FIG. 1 and FIG. 2, a coupled torsion beam axle type suspension system 1 according to the disclosure example may include a coupled torsion beam axle 10, a spindle plate 20 mounted on the coupled torsion beam axle 10 and having a mount surface 22 formed thereon, a wheel bearing assembly 40 mounted on the spindle plate 20, and a brake caliper 70 mounted on the spindle plate 20.

A trailing arm 12 is mounted on the coupled torsion beam axle 10, and a bush 14 is mounted on the trailing arm 12 so that it may be connected to the vehicle body (not shown).

The configuration and function of the trailing arm 12, the bush 14, and the coupled torsion beam axle 10 are obvious to those skilled in the art, and thus a detailed description is omitted.

The spindle plate 20 may be mounted, for example, on the trailing arm 12, and the combination and function of the spindle plate 20 and the trailing arm 12 are obvious to those skilled in the art, so a detailed description is omitted.

The wheel bearing assembly 40 may be provided with a wheel stud 16, and a wheel (not shown) may be mounted on the wheel stud 16.

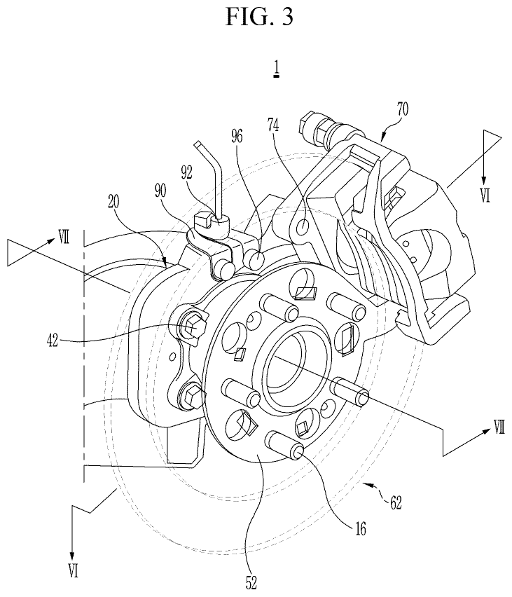

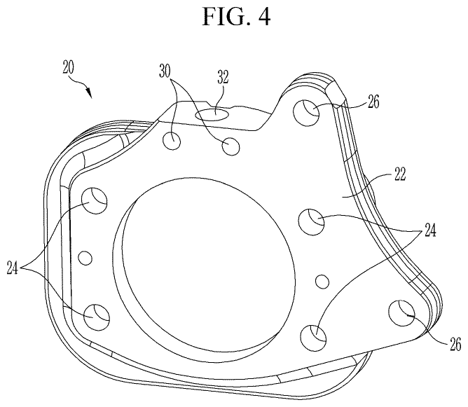

FIG. 3 is a partial projection drawing of a coupled torsion beam axle type suspension system according to the disclosure example, and FIG. 4 is a perspective view of the spindle plate of a coupled torsion beam axle type suspension system according to the disclosure example.

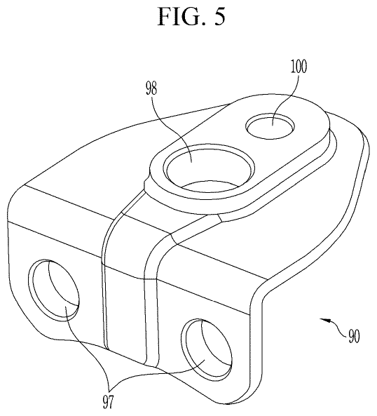

FIG. 5 is a perspective view of a wheel speed sensor bracket of a coupled torsion beam axle type suspension system according to the disclosure example.

Referring to FIG. 1 to FIG. 5, the wheel bearing assembly 40 and the brake caliper 70 may be mounted on the mount surface 22 having a flat shape.

The flat shape of the mount surface 22 means that it is processed as a single surface without a protruded shape. That is, the mount surface 22 may be a flat surface without steps.

In general, the spindle plate and spindle bracket applied to the coupled torsion beam axle type suspension system play a role in fixing the axle (bearing, caliper, etc.), and there are direct-type coupled torsion beam axle type suspension systems with spindle plates applied and offset-type coupled torsion beam axle type suspension systems with spindle brackets applied.

In the case of the spindle plate, machining must be performed multiple times due to the difference in steps between the bearing mount surface and the caliper mount surface, and the alignment dispersion of the vehicle may be large.

If a spindle bracket is applied, a separate mounting bracket must be added for the caliper mount, which may increase the overall weight of the system.

The spindle plate 20, which may be applied to the coupled torsion beam axle type suspension system 1 according to the disclosure example, has a flat shape, i.e., includes the mount surface 22 that is flat without a step. The mount surface 22 may be formed into a single plane and produced in a single processing process, thereby reducing production costs and increasing production efficiency.

A bearing assemble portion 24 for mounting the wheel bearing assembly 40 and a caliper assemble portion 26 for mounting the brake caliper 70 may be formed on the mount surface 22.

For example, the bearing assemble portion 24 and the caliper assemble portion 26 may each be formed of a plurality of holes. That is, the wheel bearing assembly 40 may be mounted on the spindle plate 20 by inserting a wheel bearing assembly mount bolt 42 into the bearing assemble portion 24. Additionally, the brake caliper 70 may be mounted to the spindle plate 20 by inserting a brake caliper mount bolt 74 into the caliper assemble portion 26.

The wheel bearing assembly 40 and the brake caliper 70 may be mounted on a single flat surface, the mount surface 22, thereby reducing the number of processing steps and enabling the commonization of parts.

The coupled torsion beam axle type suspension system 1 according to the disclosure example may further include a wheel speed sensor bracket 90 mounted on the mount surface 22, and a wheel speed sensor 92 mounted on the wheel speed sensor bracket 90.

The spindle plate 20 may have a speed sensor bracket mount hole 30 formed to mount the wheel speed sensor bracket 90.

For example, a bracket connection hole 97 is formed in the wheel speed sensor bracket 90, and a speed sensor bracket mount bolt 96 is inserted into the speed sensor bracket mount hole 30 and the bracket connection hole 97 to mount the wheel speed sensor bracket 90 to the spindle plate 20.

A speed sensor hole 32 into which the wheel speed sensor 92 is inserted may be formed in the spindle plate 20. A speed sensor insertion hole 98 is formed in the wheel speed sensor bracket 90, and the wheel speed sensor 92 may be mounted in the speed sensor hole 32 through the speed sensor insertion hole 98.

A sensor connection hole 100 is formed in the wheel speed sensor bracket 90, and the wheel speed sensor 92 may be fixed to the wheel speed sensor bracket 90 using a sensor connection bolt 102.

The wheel speed sensor bracket 90 may be formed in an “L” shape, and the speed sensor bracket mount hole 30 and the speed sensor hole 32 may be formed vertically. The speed sensor insertion hole 98 and the sensor connection hole 100 are formed in a vertical direction with respect to the bracket connection hole 97, so that the wheel speed sensor bracket 90 and the spindle plate 20 may be firmly connected.

The coupled torsion beam axle type suspension system 1 according to the disclosure example may mount the wheel speed sensor 92 using the wheel speed sensor bracket 90, so that the wheel speed sensor 92 may be engaged separately. Therefore, the entire structure of the coupled torsion beam axle type suspension system 1 may be simplified, and the ease of assembly may be improved. In addition, the wheel speed sensor 92 applied to the coupled torsion beam axle type suspension system 1 according to the disclosure example may be easily separated, so that repair or parts replacement may be simplified.

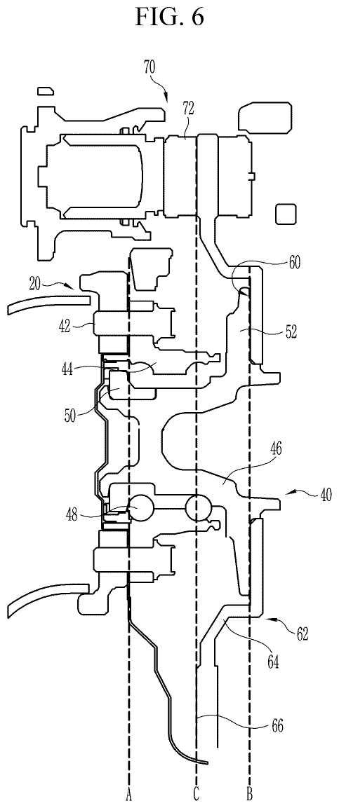

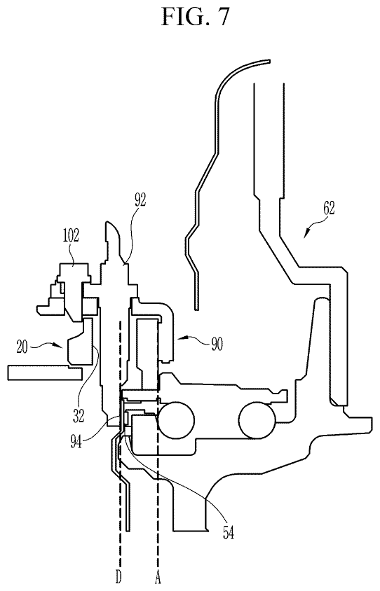

FIG. 6 is a cross-sectional view along line VI-VI of FIG. 3, and FIG. 7 is a cross-sectional view along line VII-VII of FIG. 3.

Referring to FIG. 1 to FIG. 7, the wheel bearing assembly 40 includes a first body 44 mounted to the mount surface 22 via the wheel bearing assembly mount bolt 42 and a second body 46 rotatably connected to the first body 44.

A bearing 48 is inserted between the first body 44 and the second body 46 so that the second body 46 may be rotatably mounted. A bearing retainer 50 may be mounted on the second body 46 to support the bearing 48.

The coupled torsion beam axle type suspension system 1 according to the disclosure example further includes an encoder ring 54 mounted on the wheel bearing assembly 40, and a sensing unit 94 of the wheel speed sensor 92 may be arranged adjacent to the encoder ring 54.

For example, the encoder ring 54 may be mounted on the bearing retainer 50, and the wheel speed sensor 92 may be arranged in a direction parallel to the mount surface 22, such that the sensing unit 94 of the wheel speed sensor 92 may be arranged adjacent to the encoder ring 54.

The configuration and function of the sensing unit 94 and the encoder ring 54 are obvious to those skilled in the art, so a detailed description is omitted.

Referring to FIG. 6, the wheel bearing assembly 40 may include a disk mount surface 60 formed to allow a brake disk 62 to be mounted thereon. For example, a flange 52 may be formed in the circumferential direction in the second body 46, and the disk mount surface 60 may be formed in the outward direction of the flange 52.

The brake caliper 70 may include a brake pad 72 that selectively contacts the brake disk 62 to brake the vehicle.

The relative movement of the brake pad 72 and the contact between the brake pad 72 and the brake disk 62 due to the operation of the brake caliper 70 are matters that are obvious to those skilled in the art, so a detailed description is omitted.

An imaginary extension line C of the brake surface where the brake pad 72 of the brake caliper 70 and the brake disk 62 come into contact may be placed between an imaginary extension line B of the disk mount surface 60 and an imaginary extension line A of the mount surface 22 of the spindle plate 20.

For example, the brake disk 62 may include a pad contacting surface 66 that contacts the brake pad 72 and a disk slope portion 64 formed in an inward direction of the vehicle body at the disk mount surface 60 and connected to the pad contacting surface 66. And, the imaginary extension line C of the brake surface, that is, the position of the pad contacting surface 66, is arranged between the imaginary extension line B of the disk mount surface 60 and the imaginary extension line A of the mount surface 22 of the spindle plate 20, so that the entire configuration may be made compact.

Referring to FIG. 3, FIG. 4 and FIG. 7, a mount direction D of the speed sensor hole 32 may be formed parallel to the imaginary extension line A of the mount surface 22 of the spindle plate 20.

For accurate sensing of the wheel speed sensor 92, the mounting position is very important, and according to the coupled torsion beam axle type suspension system 1 according to the disclosure example, the speed sensor bracket mount hole 30 and the caliper assemble portion 26 are formed on the mount surface 22 of a single plane so that the relative position may be precisely managed.

According to the coupled torsion beam axle type suspension system according to the disclosure example, alignment dispersion may be reduced by forming a flat shape mount surface on the spindle plate.

As previously discussed, according to the coupled torsion beam axle type suspension system according to the disclosure example, the entire weight may be reduced with a simple configuration.

According to the coupled torsion beam axle type suspension system according to the disclosure example, the wheel speed sensor bracket may be applied to simplify the structure and improve the ease of assembly.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A coupled torsion beam axle type suspension system, comprising:
a coupled torsion beam axle;
a spindle plate mounted on the coupled torsion beam axle and having a mount surface formed thereon;
a wheel bearing assembly mounted on the spindle plate; and
a brake caliper mounted on the spindle plate,
wherein the wheel bearing assembly and the brake caliper are mounted on the mount surface which has a flat shape.

2. The coupled torsion beam axle type suspension system of claim 1, wherein the mount surface is a flat surface without steps.

3. The coupled torsion beam axle type suspension system of claim 1, wherein a bearing assemble portion for mounting the wheel bearing assembly and a caliper assemble portion for mounting the brake caliper are formed on the mount surface.

4. The coupled torsion beam axle type suspension system of claim 3, wherein the bearing assemble portion and the caliper assemble portion are each formed by a plurality of holes.

5. The coupled torsion beam axle type suspension system of claim 1, further comprising:
a wheel speed sensor bracket mounted on the mount surface; and
a wheel speed sensor mounted on the wheel speed sensor bracket.

6. The coupled torsion beam axle type suspension system of claim 5, wherein the spindle plate has a speed sensor bracket mount hole formed to mount the wheel speed sensor bracket.

7. The coupled torsion beam axle type suspension system of claim 5, wherein the spindle plate has a speed sensor hole formed into which the wheel speed sensor is inserted.

8. The coupled torsion beam axle type suspension system of claim 7, further comprising:
an encoder ring mounted on the wheel bearing assembly,
wherein a sensing unit of the wheel speed sensor is arranged adjacent to the encoder ring.

9. The coupled torsion beam axle type suspension system of claim 1, wherein:
the wheel bearing assembly further comprises a disk mount surface formed to allow a brake disk to be mounted, and
a first imaginary extension line of a brake surface where a brake pad of the brake caliper and the brake disk come into contact is positioned between a second imaginary extension line of the disk mount surface and a third imaginary extension line of the mount surface of the spindle plate.

10. A coupled torsion beam axle type suspension system, comprising:
a coupled torsion beam axle;
a spindle plate mounted on the coupled torsion beam axle and having a mount surface formed thereon;
a wheel bearing assembly mounted on the spindle plate; and
a brake caliper mounted on the spindle plate,
wherein:
the wheel bearing assembly and the brake caliper are mounted on the mount surface which has a flat shape,
a bearing assemble portion for mounting the wheel bearing assembly and a caliper assemble portion for mounting the brake caliper are formed on the mount surface,
the bearing assemble portion is formed by a first plurality of holes, and
the caliper assemble portion is formed by a second plurality of holes.

11. The coupled torsion beam axle type suspension system of claim 10, further comprising:
a wheel speed sensor bracket mounted on the mount surface; and
a wheel speed sensor mounted on the wheel speed sensor bracket.

12. The coupled torsion beam axle type suspension system of claim 11, wherein the spindle plate has a speed sensor bracket mount hole formed to mount the wheel speed sensor bracket.

13. The coupled torsion beam axle type suspension system of claim 11, wherein the spindle plate has a speed sensor hole formed into which the wheel speed sensor is inserted.

14. The coupled torsion beam axle type suspension system of claim 13, further comprising:
an encoder ring mounted on the wheel bearing assembly,
wherein a sensing unit of the wheel speed sensor is arranged adjacent to the encoder ring.

15. The coupled torsion beam axle type suspension system of claim 10, wherein:
the wheel bearing assembly further comprises a disk mount surface formed to allow a brake disk to be mounted, and
a first imaginary extension line of a brake surface where a brake pad of the brake caliper and the brake disk come into contact is positioned between a second imaginary extension line of the disk mount surface and a third imaginary extension line of the mount surface of the spindle plate.

16. A coupled torsion beam axle type suspension system, comprising:
a coupled torsion beam axle;
a spindle plate mounted on the coupled torsion beam axle and having a mount surface formed thereon;
a wheel bearing assembly mounted on the spindle plate;
a brake caliper mounted on the spindle plate,
wherein the wheel bearing assembly and the brake caliper are mounted on the mount surface which has a flat shape;
a wheel speed sensor bracket mounted on the mount surface; and
a wheel speed sensor mounted on the wheel speed sensor bracket.

17. The coupled torsion beam axle type suspension system of claim 16, wherein the spindle plate has a speed sensor bracket mount hole formed to mount the wheel speed sensor bracket.

18. The coupled torsion beam axle type suspension system of claim 16, further comprising:
an encoder ring mounted on the wheel bearing assembly,
wherein:
the spindle plate has a speed sensor hole formed into which the wheel speed sensor is inserted, and
a sensing unit of the wheel speed sensor is arranged adjacent to the encoder ring.

19. The coupled torsion beam axle type suspension system of claim 16, wherein a bearing assemble portion for mounting the wheel bearing assembly and a caliper assemble portion for mounting the brake caliper are formed on the mount surface.

20. The coupled torsion beam axle type suspension system of claim 19, wherein:
the bearing assemble portion is formed by a first plurality of holes, and
the caliper assemble portion is formed by a second plurality of holes.
